(19) United States
(12) Patent Application Publication
(10) Pub. No.: US 2018/0066366 A1
(43) Pub. Date: Mar. 8, 2018

(54) RHENIUM-METAL CARBIDE-GRAPHITE ARTICLE AND METHOD

(71) Applicant: Ultramet, Pacoima, CA (US)

(72) Inventors: Brian Williams, Camarillo, CA (US); Victor M. Arrieta, Granada Hills, CA (US); Arthur J. Fortini, Pasadena, CA (US)

(73) Assignee: Ultramet, Pacoima, CA (US)

(21) Appl. No.: 15/810,058

(22) Filed: Nov. 11, 2017

Related U.S. Application Data
(62) Division of application No. 13/276,620, filed on Oct. 19, 2011, now abandoned.
(60) Provisional application No. 61/394,702, filed on Oct. 19, 2010.

(51) Int. Cl. C23C 28/00; C04B 41/90; C04B 41/00; C04B 41/52; C04B 35/52; C04B 41/45; C04B 41/50; C04B 41/51

(52) U.S. Cl. CPC C23C 28/321; C23C 28/36; C04B 41/90; C04B 41/009; C04B 41/52; C23C 28/322; C04B 41/515; Y10T 428/24942; C04B 35/522; C04B 41/4529; C04B 41/4556; C04B 41/5057; C23C 28/341

(57) ABSTRACT

A graphite-metal carbide-rhenium article of manufacture is provided, which is suitable for use as a component in the hot zone of a rocket motor at operating temperatures in excess of approximately 3,000 degrees Celsius. One side of the metal carbide is chemically bonded to the surface of the graphite, and the rhenium containing protective coating is mechanically bonded to the other side of the metal carbide. Rhenium forms a solid solution with carbon at elevated temperatures. The metal carbide interlayer serves as a diffusion barrier to prevent carbon from migrating into contact with the rhenium containing protective coating. The metal carbide is formed by a conversion process wherein a refractory metal carbide former is allowed to react with carbon in the surface of the graphite. This structure is lighter and less expensive than corresponding solid rhenium components.

### RELATED APPLICATIONS

This application claims the benefit of U.S. Provisional Application No. 61/394,702 filed Oct. 19, 2010, the content of which is incorporated by this reference in its entirety for all purpose as if fully set forth herein.

### BACKGROUND OF THE INVENTION

### Field of the Invention

The claimed subject matter relates to rhenium articles and methods wherein weight and costs are reduced by substituting graphite for some of the rhenium, and is particularly suitable for articles and methods of making articles for high temperature applications such as rocket engines wherein there is a carbon diffusion barrier between the graphite substrate and rhenium coating to prevent detrimental interaction.

### The Related Art

Rhenium has unique properties that are suited for certain high temperature applications. See, for example, Singh Pub. No. US 2003/0180571, which Publication is hereby incorporated herein by reference as though fully set forth hereat, where the high temperature properties of rhenium are summarized. The use of rhenium is constrained by the fact that it is scarce, dense, and expensive to purchase and process. Rocket engines for both liquid and solid fuel rockets require that rhenium be used in the hottest sections for purposes of structural integrity.

The weight of the amount of rhenium that had been believed to be necessary reduced the load carrying capacity of the rocket. The amount of rhenium that had been believed to be required in a rocket engine also considerably increased the costs of the rocket engine. There is a well-recognized long felt need for lighter and less expensive alternatives to solid rhenium articles.

Certain forms of graphite, particularly pressed and sintered graphite, are known to be dimensionally stable with good mechanical properties up to temperatures above approximately 3,000 degrees Celsius if protected from erosion by or reaction with hot gases. See, for example, Fatzer et al. U.S. Pat. No. 3,969,131, which is hereby incorporated herein by reference as though fully set forth hereat, where some conventional manufacturing procedures for isotropic graphite bodies are summarized.

It had been proposed to directly coat carbon and some forms of graphite with rhenium. Rhenium does not form carbides. For very high temperature applications, however, rhenium coated graphite is not practical. At temperatures above about 2,500 degrees Celsius, rhenium-carbon systems exhibit a eutectic. Also, rhenium and carbon form a solid solution.

For applications in the range of 3,700 degrees Fahrenheit (2,040 degrees Celsius), it had been proposed to apply rhenium via a chemical vapor deposition process to ceramic or graphite materials. See Christensen et al. U.S. Pat. No. 7,051,512, and Westerman et al. U.S. Pat. No. 6,343,464, both of which are hereby incorporated herein by reference as though fully set forth hereat. Christensen et al. note that rhenium clad or coated graphite structures are limited to about 2400 degrees Kelvin (about 2126 degrees Celsius). For higher temperatures (at least 3,000 degrees Kelvin), the use of rhenium alone is proposed. It had also been proposed to apply rhenium via a physical vapor deposition process to graphite materials. See Singh Pub. No. US 2003/0180571, which is hereby incorporated herein by reference as though fully set forth hereat. The use of rhenium metal as a bond between graphite and some other refractory metal such as tungsten, columbium, and tantalum, or copper, gold, silver, palladium and platinum, had been proposed. See Cacclotti U.S. Pat. No. 3,024,522, and Hofmann et al, 3,901,663, both of which patents are both hereby incorporated herein by reference as though fully set forth hereat.

The coating of carbon fiber with a deposit of tantalum carbide followed by the formation of a rhenium metal coating over the deposited tantalum carbide had been proposed. The deposited tantalum carbide was formed by the reaction of a tantalum compound with sucrose, and not by the reaction of a tantalum compound with carbon in the carbon fiber substrate. That is, the tantalum carbide coating was a deposited or overlay coating, not a conversion coating. In conversion coatings, a part of the carbon in the substrate is converted to a carbide by reaction with a reactive form of a carbide forming metal. The rhenium metal coating was formed by the hydrogen reduction of a rhenium compound. See Gibson et al. U.S. Pat. No. 4,196,230, which patent is hereby incorporated herein by reference as though fully set forth hereat.

Rhenium does not form a stable carbide, but it does form a solid solution with carbon at about 2,486 degrees Celsius. See, for example, Newkirk et al. U.S. Pat. No. 4,343,836, which patent is hereby incorporated herein by reference as though fully set forth hereat. The effect of this on the properties of rhenium coated graphite are not entirely clear, but for critical structures, such as, for example, rocket nozzles, and other structures that are exposed to very hot gases, strength, ductility, and thermal behavior considerations require that such uncertainties be avoided where possible. Also, rhenium is known to form a eutectic with carbon at approximately 2500 degrees Celsius.

Niobium, hafnium, zirconium, tantalum, and titanium all form carbides at high temperatures, generally above approximately 1,400 degrees Celsius. See, for example, Fatzer et al. U.S. Pat. No. 3,969,131, and Claar et al. U.S. Pat. No. 5,674,562, which patents are both hereby incorporated herein by reference as though fully set forth hereat. Contacting reactive forms of these elements with the surface of a graphite substrate at such temperatures results in the formation of conversion carbide coatings. The metal reacts with the carbon in the surface of the graphite substrate to form a very tightly adhered conversion carbide coating. Duplex coatings may be formed by the serial application of different metals. At substantially lower temperatures, a metallic coating forms without forming any significant amount of carbide.

Robert Tuffias and M. J. De la Rosa published a report as a conference paper, Report No. A547914, Contract No. F29601-92-C-0119, “Materials Characterization and Design for Solar-Thermal Propulsion,” which report is hereby incorporated herein by reference as though fully set forth hereat. Carbon, rhenium, hafnium carbide, tantalum carbide, niobium carbide, and zirconium carbide were investigated for use in solar powered rocket engines.

Rhenium had previously been proposed for use in the hottest sections of both solid and liquid propellant engines. Solid propellant engines run considerably hotter than liquid propellant engines, so the operational demands on the materials of construction are considerably greater in solid propellant rocket engines.

Conventional rocket motors typically operate at gas temperatures (combustion temperatures) between approximately 1,800 and 3,300 degrees Celsius. In general, the operating temperatures of the hot sections of the rocket motors are 200 degrees Celsius or more less than the gas temperatures. For example, the components in the hot section of a solid rocket motor with a gas temperature of approximately 3,300 degrees Celsius may be operating at less than approximately 3,100 degrees Celsius, and the components in a rocket motor with a gas temperature of approximately 2,000 Celsius may be operating at approximately 1,600 degrees Celsius.

In the event of a conflict between the teachings in this specification and those of any reference that is incorporated herein by reference, the teachings in this disclosure shall control. For example, published values for melting points, coefficients of thermal expansion (CTE), diffusion coefficients, and other physical properties for refractory materials are often not consistent from one published source to another. The values set forth in this present disclosure are to control as against any other published values for purposes of describing and defining this invention.

### SUMMARY

Embodiments of the claimed invention provide, for example, improved articles of manufacture that are particularly suitable for very high temperature applications above 1,800 or 2,500, or even 3,000 degrees Celsius or higher operating temperatures where low weight articles are required or desirable. Embodiments of the claimed invention further provide, for example, methods of manufacturing such improved high temperature articles of manufacture.

According to certain embodiments, a graphite-metal carbide-rhenium article of manufacture is provided. Embodiments of this article of manufacture comprise a graphite substrate. Graphite is a crystalline form of carbon, which is to be distinguished from vitreous carbon. Vitreous carbon is a glassy amorphous form of carbon. Graphite maintains its strength up to very high temperatures above 3,300 degrees Celsius and higher. The graphite substrate has a predetermined configuration and a graphite coefficient of thermal expansion. A diffusion barrier coating may be formed in a surface of a graphite substrate. The diffusion barrier coating comprises a refractory metal carbide. The diffusion barrier coating is a conversion coating that is chemically bonded to the graphite substrate. The material of the diffusion barrier coating is selected based on a combination of high melting point (above the expected end use temperature) low carbon diffusivity at the expected end use temperature, and coefficients of thermal expansion (CTE) that are well matched at the intended operating temperatures. The coefficients of thermal expansion (CTE) should be selected to minimize the risk that different expansion rates may cause the components to crack or otherwise fail in use. The diffusion barrier coating is formed by reacting carbon in the surface of the graphite with a metallic carbide precursor (reactive form of a carbide forming refractory metal, such as, for example, niobium halide gas). The carbon for the carbide forming reaction comes from the graphite substrate. The resulting diffusion barrier coating has almost the identical configuration, dimensions, and texture as the original graphite surface. The graphite is slightly porous, so the carbide forming reaction takes place at and within the surface, thus sealing the porous surface. By contrast, vitreous carbon is not porous, so conversion coatings on vitreous carbon are difficult or impossible to form to a comparable depth (nominally 0.001 inches). Deposition coatings (sometimes described as overlay coatings) are formed when an external source of reactive carbon is provided. Such overlay coatings generally alter the configuration, dimensions and/or texture of the surface of the vitreous carbon. Embodiments of diffusion barrier coatings have a carbide coefficient of thermal expansion, and low carbon diffusion coefficients up to at least approximately 3,000 degrees Celsius. At temperatures above approximately 2,000 or 2,500 degrees Celsius there is some diffusion of carbon through metal carbides according to these embodiments, however, the amount is insufficient to materially change the properties of rhenium within the expected lifetime of a very high temperature article such as a rocket nozzle. A protective coating comprising rhenium is deposited on and mechanically bonded to the diffusion barrier coating.

This mechanical bond between the metal carbide and the rhenium comprising component is much weaker than the chemical bond between the metal carbide and the graphite. The protective coating has a rhenium coefficient of thermal expansion. The diffusion barrier coating is between the graphite substrate and the protective coating. The carbide and graphite coefficients of thermal expansion differ from one another and from the rhenium coefficient of thermal expansion by no more than about 20, or in certain embodiments, 15 or 10 percent calculated on the basis of the graphite coefficient of thermal expansion. The protective coating is substantially inert to the diffusion barrier coating up to at least approximately 3,000 degrees Celsius.

Embodiments of articles of manufacture according to the present invention are capable of serving substantially the same functions that solid rhenium articles had previously served, but with substantial savings in both weight and cost. Depending on the specific design of an article, a 30 to 60 percent reduction in the amount of rhenium is possible. With certain embodiments, a reduction in the amount of rhenium, and a reduction in the costs of forming rhenium result in reducing costs by as much as from 35 to 65 percent. Certain embodiments exhibit a weight reduction of from 20 to 50 percent. The density of graphite is less than 10 percent of that of rhenium. In certain designs it may be necessary for structural purposes to use a thicker body of graphite than would be necessary with rhenium, but because of the density difference between these materials, a thicker graphite body does not substantially increase the weight of the article.

According to certain embodiments, the graphite coefficient of thermal expansion of the graphite substrate is in the range of from approximately 5 to 9, and in further embodiments, from 6 to 9, or 7 to 8.7 parts per million parts per degree Kelvin at temperatures in the range of from approximately 1,500 to 3,000 degrees Celsius. The graphite coefficient of thermal expansion for commercially available forms of graphite varies somewhat depending on the materials from which the graphite is prepared and the details of the processing steps by which it is formed. Certain forms of pressed and sintered graphite supplied by Poco Graphite have graphite coefficients of thermal expansion in the range of from approximately 7.7 to 8.6 parts per million parts per degree Kelvin at temperatures in the range of from approximately 1,500 to 3,000 degrees Celsius.

The graphite, carbide, and rhenium coefficients of thermal expansion vary slightly with temperature. The values disclosed herein are average values for the operating temperature range of from approximately 1,500 to 3,000 degrees Celsius.

According to certain embodiments, the refractory metal carbide comprises niobium carbide, or zirconium carbide, or hafnium carbide, or tantalum carbide, or titanium carbide, or molybdenum carbide, or mixtures thereof. Where more than one refractory metal carbide is employed in an embodiment, different carbide layers may be formed serially, or mixed reactive metal carbide formers (two or more from the carbides stated above) may be employed to form a mixed carbide layer.

According to certain embodiments, the protective coating comprises rhenium, and the graphite coefficient of thermal expansion is in the range of from approximately 5 to 9 parts per million parts per degree Kelvin at temperatures in the range of from approximately 1,500 to 3,000 degrees Celsius. According to certain embodiments, the protective coating is an alloy of rhenium, such as, for example, rhenium-tungsten, rhenium-tantalum, and rhenium-molybdenum.

According to further embodiments, the protective coating is a composite of rhenium or rhenium alloy and a dispersed refractory carbide phase. According to certain embodiments, the dispersed refractory carbide is in nano-particle form. Such dispersed refractory carbides include, for example, hafnium carbide, zirconium carbide, tantalum carbide, niobium carbide. Rhenium coatings with dispersed carbides are generally formed by powder processing, for example, pressed-and-sintered, or thermal spray.

Certain embodiments comprise articles of manufacture that include graphite substrates with predetermined configurations and graphite coefficients of thermal expansion (CTE). Such predetermined configurations in certain embodiments include massive forms, and may include features that provide mechanical fastening members in the completed article. Such configured massive forms are to be distinguished from filamentary forms. Diffusion barrier coatings comprising refractory metal carbides are chemically bonded to the graphite substrates. The diffusion barrier coatings have carbide coefficients of thermal expansion (CTE). Protective coatings comprising rhenium are mechanically bonded to the diffusion barrier coatings. The protective coatings have rhenium coefficients of thermal expansion (CTE).

For many embodiments, the coefficients of thermal expansion of the three major components should be as close as possible to one another. This minimizes the thermal stress that these composites experience at operating temperatures that are frequently above 2,500 or even 3,000 degrees Celsius. The graphite, carbide, and rhenium coefficients of thermal expansion for a particular embodiment are all within approximately the same 20, 15, or 10, percent expansion range calculated on the basis of smallest coefficient of thermal expansion among the three major components. In certain limited additional embodiments the percent expansion range may be as much as 25 or even 30 percent. A percent expansion range is calculated on the basis of the coefficient of thermal expansion of the component with the lowest coefficient of thermal expansion of the three major components.

The largest of the coefficients of thermal expansion between the graphite substrates, the diffusion barrier coatings, and the protective coatings should be no more than approximately 20, and in further embodiments, 25 or 30 percent higher than the smallest coefficients of thermal expansion. For example, where the coefficient of thermal expansion of a graphite substrate (JP-1091) is approximately 6.1, titanium carbide, with a coefficient of thermal expansion of approximately 7.9, may be used, resulting in an approximately 30 percent expansion range—(100)(7.9−6.1)/6.1≈30 percent. The protective coating should have a coefficient of thermal expansion somewhere between approximately 7.9 and 6.1, so as to fall within approximately the same 30 percent expansion range. Rhenium metal and most rhenium alloys have coefficients of thermal expansion that fall within this range. As a further example, an approximately 16 percent expansion range results from the use of Rhenium as the protective coating, with a coefficient of thermal expansion of approximately 6.9, and a graphite with a coefficient of thermal expansion of approximately 8.0−(100)(8.0−6.9)/6.9≈16 percent. The diffusion barrier coating should have a coefficient of thermal expansion between approximately 8.0 and 6.9, so as to fall within approximately the same 16 percent expansion range. Also, for example, an approximately 6 percent expansion range results from the use of components where the graphite substrate has a coefficient of thermal expansion of approximately 6.5, the diffusion barrier coating (niobium carbide) and the protective coating (rhenium) both have a coefficient of thermal expansion of approximately 6.9−(100)(6.9−6.5)/6.5≈6 percent. All of the major components fall within approximately the same 6 percent expansion range.

According to embodiments of the present invention, a method of manufacturing an article comprises selecting a graphite substrate, which has a predetermined configuration, a surface and a graphite coefficient of thermal expansion. A diffusion barrier coating comprising refractory metal carbide is formed in the surface of the graphite substrate by allowing a reactive form of carbide forming refractory metal to react with carbon in the surface of the graphite substrate. This is a conversion coating. According to certain embodiments, the diffusion barrier coating has a carbide coefficient of thermal expansion, and has a carbon diffusion coefficient of less than approximately 1 times 10⁻⁶ centimeters squared per second at a temperature of approximately 2,500 degrees Kelvin, or in further embodiments a carbon diffusion coefficient of less than approximately 1 times 10^{-5.5} centimeters squared per second at a temperature of approximately 3,000 degrees Kelvin. A deposited protective coating comprising rhenium is formed on and mechanically bonded to the diffusion barrier coating. This is an overlay coating. The protective coating has a rhenium coefficient of thermal expansion. The graphite, carbide, and rhenium coefficients of thermal expansion are within the same 30, or 25, or 20, or 15, or 10 percent expansion range calculated on the basis of the coefficient of thermal expansion of the component with the lowest coefficient of thermal expansion.

The diffusion barrier and protective coatings according to certain embodiments are formed at temperatures above 600, or in certain further embodiments at temperatures above 1,000 or 1,400 degrees Celsius. In general, thermal stress at the temperatures at which these articles are used is reduced by forming them at elevated temperatures above approximately 600 degrees Celsius.

### BRIEF DESCRIPTION OF THE DRAWINGS

Further advantages and features of the present invention will become apparent to those skilled in the art with the benefit of the following detailed description of the preferred embodiments and upon reference to the accompanying drawings in which:

FIG. 1 is a diagrammatic representation of a fragmented cross-sectional view of a rhenium-metal carbide-graphite article according to the present invention;

FIG. 2 is a diagrammatic representation of certain steps in a method of forming a composite graphite-metal carbide-rhenium article; and

FIG. 3 is a chart prepared from previously published data, which includes curves that approximately depict the diffusivity of carbon in various refractory carbides at elevated temperatures.

### DETAILED DESCRIPTION OF THE EMBODIMENTS

In the following description, numerous specific details are set forth in order to provide a thorough understanding of the various embodiments of the claimed subject matter. One skilled in the relevant art will recognize, however, that these embodiments can be practiced without one or more of the specific details, or with a number of other methods or compositions.

References throughout this specification to “one embodiment,” “certain embodiments,” “additional embodiments,” further embodiments,” or “an embodiment,” or words of similar meaning, means that a particular feature, structure, or characteristic described in connection with the embodiment is included in at least one embodiment of the present claimed subject matter. Thus, the appearances of the phrases “in one embodiment” or “in an embodiment,” or phrases of similar meaning, in various places throughout this specification are not necessarily all referring to the same embodiment. Furthermore, the particular features, structures, or characteristics may be combined in any suitable manner in one or more embodiments.

Certain physical properties of selected components are set forth in Table 1. The values set forth in this Table 1 are taken from previously published sources. There are other published sources that include different values for these physical properties. The values set forth in Table 1 are believed to be the most accurate that are available.

TABLE 1

| | Coefficient Of | | Approximate |
|---|---|---|---|
| | Thermal | | Diffusion |
| | Expansion In | | Coefficient for |
| | parts per million | | Carbon In |
| | per degree | Melting Point In | Component In |
| Component | Kelvin (CTE) | Degrees Kelvin | cm²/sec. |
| Graphite | 7.7 | Above 3900° K | Not applicable |
| ZXF-5Q | | | |
| Graphite | 8.6 | Above 3900° K | Not applicable |
| ACF-10Q | | | |
| Graphite | 8.4 | Above 3900° K | Not applicable |
| AXF-5Q | | | |
| Graphite | 7.8 | Above 3900° K | Not applicable |
| AXZ-5Q | | | |
| Graphite | 8.6 | Above 3900° K | Not applicable |
| AXF-5QC | | | |
| Graphite | 8.2 | Above 3900 K | Not applicable |
| AXM-5Q | | | |
| JP-1091 | 6.1 | Above 3900 K | Not applicable |
| ISO-88 | 6.5 | Above 3900 K | Not applicable |
| Rhenium | 6.9 | 3450° K | Forms solid |
| | | | solution at |
| | | | approximately |
| | | | 1773 K |
| Niobium | 6.9 | 3890 K | 1 × 10⁻⁷ at |
| Carbide | | | approximately |
| | | | 2800 K |
| Zirconium | 7.3 | 3690° K | 1 × 10⁻⁷ at |
| Carbide | | | approximately |
| | | | 3100 K |
| Tantalum | 6.6 | 4260° K | 1 × 10⁻⁷ at |
| Carbide | | | approximately |
| | | | 2800 K |
| Titanium | 7.9 | 3340° K | 1 × 10⁻⁷ at |
| Carbide | | | approximately |
| | | | 2300 K |
| Hafnium | 6.8 | 4220° K | 1 × 10⁻⁷ at |
| Carbide | | | approximately |
| | | | 2900 K |
| Molybdenum | 6.0 | 2965° K | 1 × 10⁻⁷ at |
| Carbide | | | approximately |
| | | | 2300 K |

Referring particularly to the drawings for purposes of illustration, and not limitation, a broken cross-section of an embodiment of and article is depicted generally at 10. Article 10 includes a graphite substrate 12, a diffusion barrier coating 14 comprised of metal carbide, and a protective coating 20 comprised of rhenium. Diffusion barrier coating 14 is a conversion coating that is chemically bonded to graphite substrate 12. At the junction between graphite substrate 12 and diffusion barrier coating 14 the metal carbide grades into the graphite through graded region 16. Graded region 16 is shown somewhat thickened for the purposes of illustration. It is generally thinner than illustrated relative to the rest of diffusion barrier coating 14. In graded region 16 there is a mixture of carbon and metallic carbide. Exposed surface 18 of protective coating 20 is adapted, for example, to being exposed to hot exhaust gases in a rocket engine assembly.

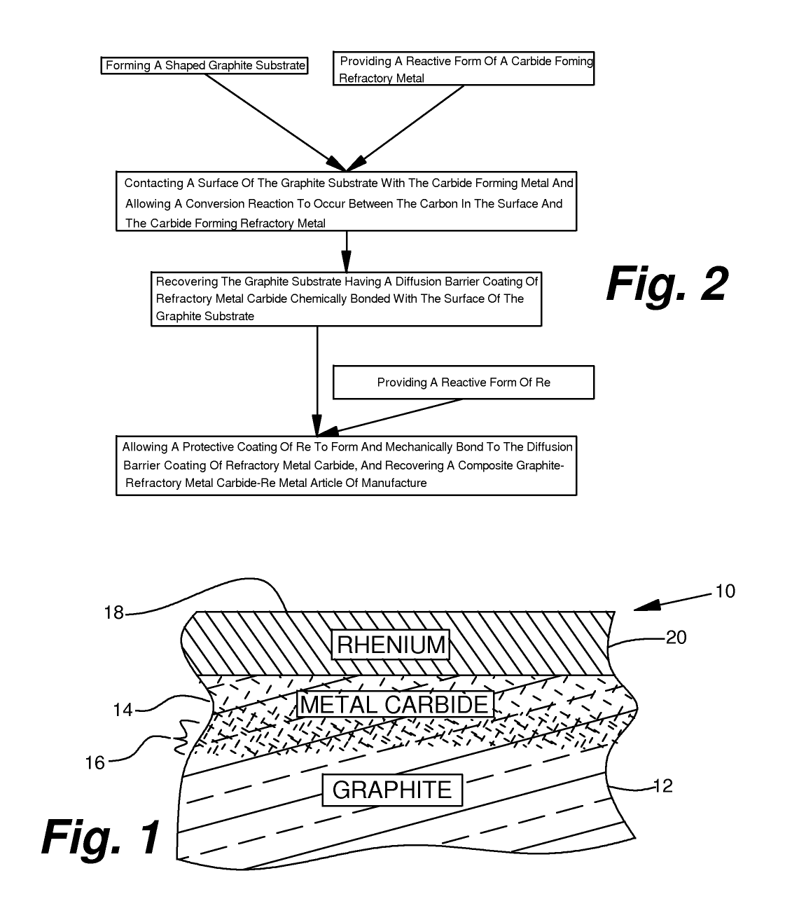

FIG. 2 is a flow chart that diagrammatically depicts a method of forming articles according to the present invention. A graphite substrate is selected and configured. The shaping may be performed by molding a powdered mass of graphite particles under pressure and sintering conditions to form a net or near net shape article with a massive form. In further embodiments, a solid mass of graphite is machined to a desired configuration. The graphite in certain embodiments is in a massive form rather than in filaments or fine particles. The configuration of the graphite substrate determines the configuration of the finished article. Such articles are useful in extremely high temperature applications such as those encountered in the hot sections of liquid or solid propellant rocket engines (for example, throats, nozzles, and combustion chambers), in heat shielding, and the like. The graphite substrate serves as a graphite workpiece for the diffusion barrier coating forming step. According to certain embodiments, graphite substrates also serve as the cores of sandwich structures. In such structures protective coatings (facesheets comprising rhenium), and diffusion barrier coating interlayers (consisting essentially of refractory metal carbide) are formed on each of the opposed sides of a graphite substrate, so there is a diffusion barrier coating between each face sheet and the graphite substrate. The respective metal carbide interlayers have the same or different dimensions, physical, and chemical properties, depending on the requirements of a specific application. The respective facesheets also have the same or different dimensions and properties depending on the requirements of a specific application.

A reactive form of a carbide forming refractory metal is provided for carrying out a conversion reaction with carbon in the surface of the graphite. Such metal carbide precursors and carbide forming reactions are conventional and well known in the art, and include, for example, the use of refractory metal halides as metal carbide precursors. The metal halides are introduced in the vapor phase and are reduced by hydrogen to provide a source of refractory metal that reacts with carbon at elevated temperatures. Such reactions are conventionally carried out at elevated temperatures above approximately 1000 degrees Celsius. The carbide forming reaction takes place within the surface of the graphite substrate. As the carbide coating thickens the rate of formation slows down because the reactants must penetrate through the carbide coating that has already formed to react with the carbon. A diffusion barrier coating is formed when the conversion reaction is carried out to the extent that a coating having a uniform thickness of at least about 0.3 mils, or, in further embodiments, about 0.5, or 1, or 2, or 3, or 4 to 5 mils is formed. At a thickness of 0.3 mils the coating serves as an effective barrier against the diffusion of carbon from the graphite through this metal carbide coating. The amount of carbon that diffuses through the diffusion barrier coating at operating temperatures above 2,000 or 2,500 degrees Celsius is further reduced as this coating increases in thickness to about 0.5, or 1, or even about 2 mils in certain embodiments. Further thickening tends to be counterproductive in many embodiments, because of an increased incidence of cracking of the coating.

Metallic carbide coatings withstand the stress of coefficients of thermal expansion mismatches better when they are thin. For example, the temperature gradient across a thin coating of 1 mil thickness will be less during start-up than across a coating with a thickness of 5 mils.

The conversion reaction of metal carbide precursors with carbon in the surfaces of slightly porous graphite substrates results in the formation of metal carbide coatings that are chemically bonded with the surface of the graphite substrate. The intermediate article of manufacture that is recovered from this conversion reaction is a metal carbide coated graphite substrate in which the configuration, dimension, and texture of the surface of the original graphite substrate have not been significantly altered. That is, the dimensions of this intermediate article are within less than one mil (0.001 inches) of those of the original graphite substrate when the carbide coating. Because the reactive carbon comes from within the surface of the graphite substrate, there is no surface build up such as occurs with overlay or deposited coatings. The metal carbides may be formed using a mixture of different refractory metals so as to achieve certain diffusion coefficients, melting points, and/or coefficients of thermal expansion as may be necessary or desired for particular applications.

The metal carbide coated graphite substrate serves as a carbide coated workpiece for the step in which a protective coating is formed by the application of a mechanically bonded overlay or deposited coating that comprises rhenium.

Formation of a rhenium containing protective coating is carried out using conventional procedures. Such conventional procedures include, for example, chemical vapor deposition (CVD), powder metallurgy techniques, and thermal spraying such as, for example, plasma spray. Electroforming procedures at approximately room temperature have also been used, as well as physical vapor deposition procedures (PVD). As those skilled in the art know, inspection of the grain structure and impurity levels of the rhenium comprising protective coating generally reveals the method of formation. The formation of the protective coatings is typically carried out to the extent that the coating is at least approximately 2, and in certain embodiments at least about 4, or 5, or 7, or more mils thick. The thickness of the protective coating selected depending on the intended end use for a particular article of manufacture. For large articles that are expected to repeatedly withstand prolonged exposure to temperatures above 2,500 or 3,000 degrees Celsius, the protective coating in some embodiments may be as much as 0.05, or 0.5, or more inches thick.

Rhenium is almost impossible to weld. In order to overcome this problem, a deposit of some other refractory metal that is weldable is formed onto the protective coating where welds are desired. For example, niobium may be welded and may be deposited on and bonded to rhenium by chemical vapor deposition. High temperature super alloys (for example, may be welded and may be deposited on and bonded to rhenium by conventional plasma spray techniques. Niobium sleeves were conventionally applied over prior rhenium combustion chambers that were used in prior satellite propulsion systems. This allows for welding attachment of injectors and nozzles. Also, mechanical attachment features may be provided so that grooves, bumps, ridges or other physical mounting features appear in the protective coating (rhenium) surface. Such mechanical attachment features may be provide by shaping the graphite substrate, or by otherwise altering selected dimensions of the surface of the protective coating.

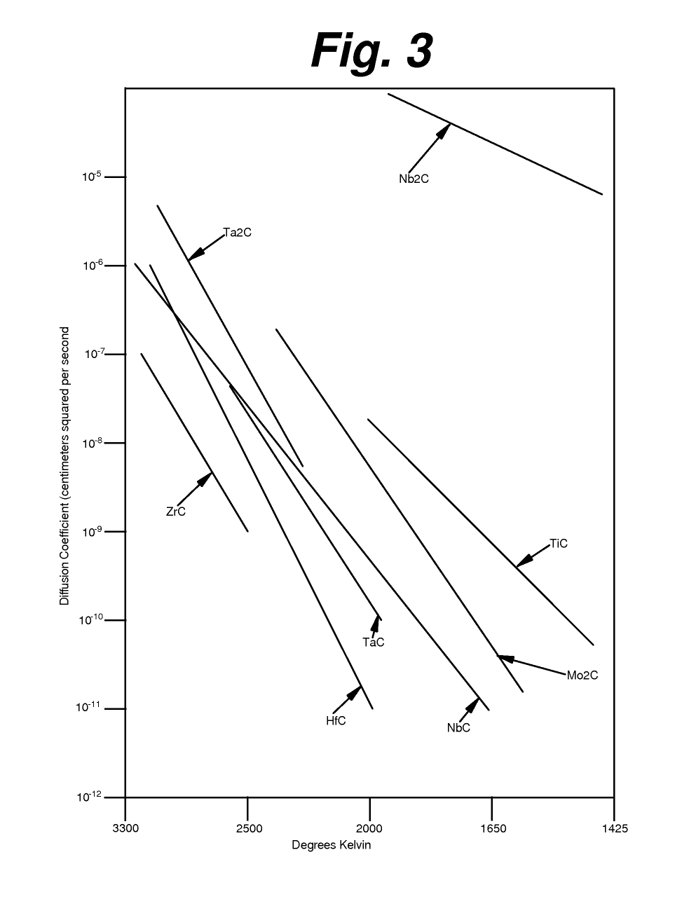

FIG. 3 is a chart that depicts the diffusion coefficients of various refractory metal carbides against temperature. The diffusion coefficients increase with increasing temperature. Zirconium carbide, hafnium carbide, tantalum carbide, and molybdenum carbide all have diffusion coefficients of less than or about 1 times 10⁻⁶ centimeters squared per second (cm²/sec.) at a temperature of approximately 2,500 degrees Kelvin. Zirconium carbide, hafnium carbide, tantalum carbide, and niobium carbide have diffusion coefficients of less than about 1 times 10^{-5.5} cm²/sec. at a temperature of approximately 3,000 degrees Kelvin.

The present invention finds particular application when applied to pintles (also known as poppets) and throats (also known as seats) of various sizes for use in high performance (high temperature, long range) missile solid rocket motors.

According to one embodiment, articles according to the present invention are produced by a series of steps. A graphite substrate is machined to the desired size and configuration, taking into account the thickness of rhenium that will be required to survive the thermomechanical loads and thermochemical environment of the application. The configuration of the graphite substrate may also provide for the mechanical attachment of the completed article to a supporting structure. The machined graphite substrate is subjected to a high temperature (greater than 2500 degrees Celsius) heat treatment/outgassing treatment in a chlorine atmosphere to remove metallic impurities and other contaminants from the substrate. A refractory metal carbide diffusion barrier interlayer is formed with the surface of the graphite substrate by allowing a metal halide to react with the graphite surface to form the desired metal carbide conversion coating. A deposit of rhenium metal is formed on the diffusion barrier coating by a chemical vapor deposition operation. This chemical vapor deposition operation is performed via the thermal decomposition of rhenium chloride in the temperature range of 1000-1400 degrees Celsius. The chemical vapor deposition operation is carried out until the deposit reaches the required thickness. The exterior surface of the rhenium layer may be ground or otherwise machined to the desired final dimensions, if necessary.

While the detailed description of the claimed subject matter has been described with reference to multiple embodiments, it should be understood by those skilled in the art that various changes and modifications may be made and equivalents may be substituted for elements thereof without departing from the scope of the claimed subject matter. Therefore, the claimed subject matter is not limited to the various disclosed embodiments including the best mode contemplated for carrying out the claimed subject matter, but instead includes all possible embodiments that fall under the subject matter to be claimed.

1-14: (canceled)

15: A method of manufacturing an article comprising:
selecting a graphite substrate, said graphite substrate having a predetermined configuration, a surface and a graphite coefficient of thermal expansion;
forming a diffusion barrier coating comprising refractory metal carbide chemically bonded to said graphite substrate by allowing a reactive form of said refractory metal to react with carbon in said surface, said diffusion barrier coating having a carbide coefficient of thermal expansion, and a carbon diffusion coefficient of less than approximately 1 times 10⁻⁶ centimeters squared per second at a temperature of approximately 2,500 degrees Kelvin; and
depositing a protective coating comprising rhenium on said diffusion barrier coating, and allowing said protective coating to mechanically bond to said diffusion barrier coating, said protective coating having a rhenium coefficient of thermal expansion, the largest of said graphite, carbide, and rhenium coefficients of thermal expansion being no more than approximately 30 percent larger than the smallest of said graphite, carbide, and rhenium coefficients of thermal expansion.

16: A method of manufacturing an article of claim 15 comprising carrying out said depositing at a temperature above approximately 600 degrees Celsius.

17: A method of manufacturing an article of claim 15 comprising selecting said graphite substrate, diffusion barrier coating, and protective coating so that the largest of said graphite, carbide, and rhenium coefficients of thermal expansion are no more than approximately 30 percent larger than the smallest of said graphite, carbide, and rhenium coefficients of thermal expansion.

18: A method of manufacturing an article of claim 15 comprising carrying out said forming so that a diffusion barrier coating having a thickness of between approximately 0.3 and 2 mils is achieved.

19: A method of manufacturing an article of claim 15 comprising carrying out said depositing so that a protective coating having a thickness of at least approximately 2 mils is achieved.

20: A method of manufacturing an article of claim 15 comprising configuring said graphite substrate to form mechanical attachment features in said protective coating.

21: A method of manufacturing an article of claim 15 including providing mechanical attachment features in said protective coating.
